(19) United States
(12) Patent Application Publication
(10) Pub. No.: US 2014/0180441 A1
(43) Pub. Date: Jun. 26, 2014

(54) CONTROL DEVICE OF VEHICLE AND CONTROL METHOD THEREFOR

(71) Applicants: Yasuhiro HIASA, Nagoya-shi (JP); Atsushi TABATA, Okazaki-shi (JP); Tooru MATSUBARA, Toyota-shi (JP); Takeshi KITAHATA, Toyota-shi (JP); Tatsuya IMAMURA, Okazaki-shi (JP); Kenta KUMAZAKI, Toyota-shi (JP); Kouichi OKUDA, Toyota-shi (JP); Masafumi YAMAMOTO, Toyota-shi (JP); Keita IMAI, Toyota-shi (JP); Keisuke OMURO, Toyota-shi (JP)

(72) Inventors: Yasuhiro HIASA, Nagoya-shi (JP); Atsushi TABATA, Okazaki-shi (JP); Tooru MATSUBARA, Toyota-shi (JP); Takeshi KITAHATA, Toyota-shi (JP); Tatsuya IMAMURA, Okazaki-shi (JP); Kenta KUMAZAKI, Toyota-shi (JP); Kouichi OKUDA, Toyota-shi (JP); Masafumi YAMAMOTO, Toyota-shi (JP); Keita IMAI, Toyota-shi (JP); Keisuke OMURO, Toyota-shi (JP)

(73) Assignee: TOYOTA JIDOSHA KABUSHIKI KAISHA, Toyota-shi (JP)

(21) Appl. No.: 14/132,636

(22) Filed: Dec. 18, 2013

(30) Foreign Application Priority Data
Dec. 26, 2012 (JP) 2012-282554

(51) Int. Cl. B60W 20/00

(52) U.S. Cl. CPC B60W 20/10
USPC 700/22

(57) ABSTRACT

Provided is a control device of a vehicle, the vehicle having an electric motor and an engine. The control device includes an operating device and a controller. The operating device is configured to be selected a running capability of the vehicle. The controller configured to increase a running capability to be achieved using the electric motor alone, in a case where the vehicle travels using the electric motor alone according to the selected running capability, as compared with a case where the vehicle travels using the electric motor alone and the running capability is not selected.

### INCORPORATION BY REFERENCE

The disclosure of Japanese Patent Application No. 2012-282554 filed on Dec. 26, 2012 including the specification, drawings and abstract is incorporated herein by reference in its entirety.

### BACKGROUND OF THE INVENTION

1. Field of the Invention

The invention relates to a control device and to a control method for a vehicle. In particular, the invention relates to a technology for controlling the output of an electric motor at a time when the running capability of a vehicle is selected.

2. Description of Related Art

Vehicles being marketed include vehicles that have installed therein an engine and an electric motor as drive sources. Such vehicles are referred to as hybrid vehicles (HVs) or electric automobiles having a range extender function.

As an example of such vehicles, Japanese Patent Application Publication No. 2009-120043 (JP 2009-120043 A) discloses a drive unit of a HV that allows executing an electric travel mode in which the vehicle is caused to travel using an electric motor in a state where the operation of an internal combustion engine is discontinued, and an engine travel mode in which the vehicle is caused to travel using motive power that is outputted by the internal combustion engine. Further, JP 2009-120043 A indicates that prohibition of the engine travel mode is lifted and the travel mode is changed over to the engine travel mode when a depression amount of an accelerator pedal exceeds a predefined amount.

### SUMMARY OF THE INVENTION

Inadequate road surfaces require a higher running performance than paved roads. In a configuration where the engine is started when the depression amount of an accelerator pedal exceeds a predefined amount, therefore, the frequency with which the engine is started may increase in inadequate road surfaces as compared with that in paved roads. However, a need may also arise in that the vehicle travels using only the electric motor, with the engine shut off as much as possible, also for inadequate road surfaces.

The invention provides a technology that enables wide-range travel in a travel mode that relies on an electric motor.

A first aspect of the invention is a control device of a vehicle, the vehicle having an electric motor and an engine, and the control device includes an operating device and a controller. The operating device is configured to select a running capability of the vehicle. The controller is configured to increase a running capability to be achieved using the electric motor alone, in a case where the vehicle travels using the electric motor alone according to the running capability selected, as compared with a case where the vehicle travels using the electric motor alone and the running capability is not selected. In the above configuration, there is increased the running capability to be achieved using an electric motor alone in a case where the running capability of the vehicle has been selected. The occasions where the engine is started can be made fewer as a result. Accordingly, it becomes possible to perform wide-range travel in a travel mode that relies on an electric motor.

In the control device, the controller may be configured to calculate a first running capability to be achieved using the electric motor alone when the running capability is selected, to be larger than a second running capability to be achieved using the electric motor alone when the running capability is not selected, and the controller may be configured to cause the vehicle to travel using the electric motor alone, when the selected running capability is equal to or smaller than the first running capability. By virtue of the above configuration, the vehicle can be caused to travel using the electric motor alone, upon verification that the selected running capability can be achieved using an electric motor alone. The occasions where the engine is started can be made yet fewer as a result.

In the control device, the controller may be configured to cause the vehicle to travel using the engine when the selected running capability exceeds the first running capability. The above configuration allows achieving the selected running capability through operation of the engine.

The control device may further includes a notifying device. The notifying device may be configured to notify the driver that the selected running capability cannot be achieved when the selected running capability exceeds the running capability to be achieved using the engine. The above configuration allows the driver to grasp that the selected running capability cannot be achieved. The driver can therefore respond accordingly by, for instance, modifying the route of the vehicle or by lowering the running capability.

In the control device, the electric motor may be installed in plurality, and the controller may be configured to cause the vehicle to travel using the plurality of electric motors when the selected running capability exceeds the running capability to be achieved using one of the electric motors alone. Since a plurality of electric motors are used in n the above configuration, the electric motor running capability is multiplied.

In the control device, the running capability may be defined by the torque outputted by the vehicle and a continuous output time of the vehicle. For instance, the continuous output time of the electric motor depends on the remaining capacity of a battery. Therefore, defining the running capability not only on the basis of torque but also on the basis of duration makes it possible to express more accurately a running capability that has the usage limit of the electric motor factored in.

In the control device, the continuous output time of the vehicle may be set to a longest time over which a predefined torque can be continuously outputted.

In the control device, the torque at the time of achieving the selected running capability using the engine may be set to a maximum torque of the engine and a maximum torque of the electric motor.

In the control device, the torque at the time of achieving the selected running capability using the electric motor may be set to a maximum torque of the electric motor.

In the control device, the operating device that may includes a display device and the notifying device.

A second aspect of the invention is a control method for a vehicle. The vehicle includes an electric motor and an engine. The control method includes increasing a running capability to be achieved using the electric motor alone, in a case where the vehicle travels using the electric motor alone according to the running capability that is selected, as compared with a case where the vehicle travels using the electric motor alone and the running capability is not selected.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic configuration diagram illustrating a HV according to an embodiment of the invention;

FIG. 2 is a diagram illustrating a hybrid system according to the embodiment;

FIG. 3 is a diagram illustrating another example of a hybrid system according to the embodiment;

FIG. 4 is a diagram illustrating an automatic transmission according to the embodiment;

FIG. 5 is a diagram illustrating an operation chart of the automatic transmission according to the embodiment;

FIG. 6 is a diagram illustrating a screen of a touch panel at the time of setting of a running performance level, according to the embodiment;

FIG. 7 is a diagram illustrating running capability for each running performance level, according to the embodiment;

FIG. 8 is a diagram illustrating running capability and running capability to be achieved, for each running performance level, according to the embodiment;

FIG. 9 is a diagram illustrating the screen of the touch panel at a time where a selected running capability cannot be achieved, according to the embodiment;

FIG. 10 is a diagram illustrating a relationship between battery temperature and maximum torque of a motor generator, according to the embodiment;

FIG. 11 is a diagram illustrating running capability that changes depending on battery temperature, according to the embodiment;

FIG. 12 is a diagram illustrating a relationship between remaining capacity of the battery and continuous output time of torque, according to the embodiment;

FIG. 13 is a diagram illustrating running capability that changes depending on the remaining capacity of the battery, according to the embodiment;

FIG. 14 is a diagram illustrating torque of the motor generator according to the embodiment;

FIG. 15 is a diagram illustrating running capability to be achieved upon occurrence of single-phase lock, according to the embodiment;

FIG. 16 is a diagram comparing running capability to be achieved using one motor generator alone and running capability to be achieved using two motor generators, according to the embodiment;

FIG. 17 is a colinear chart in an electric vehicle (EV) mode in which two motor generators are used in the hybrid system illustrated in FIG. 2 according to the embodiment:

FIG. 18 is a colinear chart in an EV mode in which two motor generators are used in the hybrid system illustrated in FIG. 3 according to the embodiment:

FIG. 19 is a colinear chart at the time of execution of torque assist by slip control in the hybrid system illustrated in FIG. 3 according to the embodiment;

FIG. 20 is a diagram illustrating running capability to be achieved by slip control, according to the embodiment;

FIG. 21 is a flowchart illustrating a process executed by an ECU according to the embodiment; and

FIG. 22 is a flowchart illustrating a process executed by an ECU, according to the embodiment.

### DETAILED DESCRIPTION OF EMBODIMENTS

Embodiments of the invention are explained next with reference to accompanying drawings. In the explanation below, identical components are denoted by identical reference numerals. The denomination and functions of the components are likewise identical. Accordingly, an explanation thereof will not be repeated.

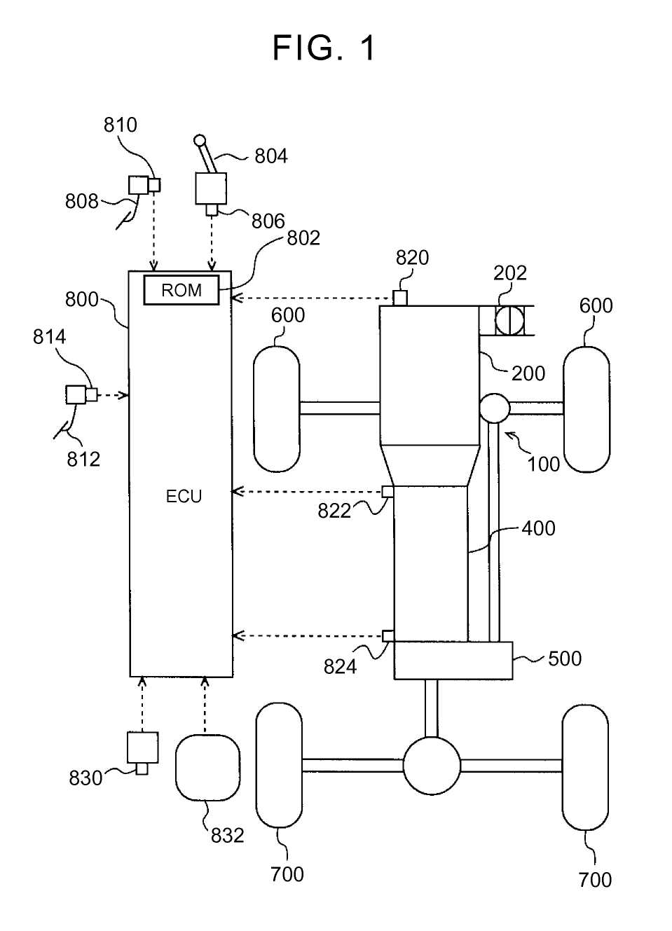

A HV according to an embodiment of the invention will be explained with reference to FIG. 1. The HV illustrated in FIG. 1 is a four-wheel drive vehicle. The vehicle may be other than a four-wheel drive vehicle. The vehicle described as a HV in the embodiment encompasses also plug-in HVs the battery whereof can be charged using electric power supplied from an external power source, as well as electric automobiles that are provided with a range extender wherein an engine is mainly used for generating electric power.

The HV has a hybrid system 100 as a drive source, an automatic transmission 400, a transfer 500, front wheels 600, rear wheels 700, and an electronic control unit (ECU, regarded as a controller) 800. The control device according to the embodiment, for instance, is achieved through execution of a program that is recorded in a read-only memory (ROM) 802 of the ECU 800. The power train of the HV includes the hybrid system 100 and the automatic transmission 400.

An engine 200 of the hybrid system 100 is an internal combustion engine wherein intake air and fuel injected by an injector are burned in combustion chambers of cylinders. The pistons in the cylinders are pushed down as a result of combustion, and a crankshaft is caused to rotate as a result. The amount of air taken into the engine 200 (load of the engine 200) is regulated by an electronic throttle valve 202. The amount of air that is taken into the engine 200 may be configured so as to be adjusted through modification of the lift and/or opening-closing phase of an inlet valve (not shown) and/or exhaust valve (not shown), in addition to or instead of, the electronic throttle valve 202.

The automatic transmission 400 is connected to an output shaft of the hybrid system 100. The driving force outputted by the automatic transmission 400 is transmitted to the front wheels 600 and the rear wheels 700 via the transfer 500.

Detection signals from a position switch 806 of a shift lever 804, an accelerator depression amount sensor 810 of an accelerator pedal 808, a depression force sensor 814 of a brake pedal 812, an engine revolutions sensor 820, a input shaft revolutions sensor 822, an output shaft revolutions sensor 824 and so forth are inputted to the ECU 800.

The position of the shift lever 804 is detected by the position switch 806. The position switch 806 transmits a signal denoting the detection result to the ECU 800. Shifting in the automatic transmission 400 is performed automatically in accordance with the position of the shift lever 804.

The accelerator depression amount sensor 810 detects a depression amount of the accelerator pedal 808, and transmits, to the ECU 800, a signal that denotes the detection result. The depression force sensor 814 detects a depression force of the brake pedal 812 (force exerted by the driver on the brake pedal 812) and transmits a signal denoting the detection result to the ECU 800.

The engine revolutions sensor 820 detects the revolutions (engine revolutions NE) of the output shaft (crankshaft) of the engine 200, and transmits a signal denoting the detection result to the ECU 800. The input shaft revolutions sensor 822 detects the input shaft revolutions NI of the automatic transmission 400, and transmits a signal denoting the detection result to the ECU 800. The output shaft revolutions sensor 824 detects output shaft revolutions NO of the automatic transmission 400, and transmits a signal denoting the detection result to the ECU 800.

The vehicle speed of the HV is calculated on the basis of the output shaft revolutions NO of the automatic transmission 400. Various techniques may be resorted to in methods for calculating vehicle speed, and hence a detailed explanation thereof will not be repeated herein.

Signals from an off-road switch 830 and a touch panel (regarded as an operating device) 832 that are operated by the driver are inputted to the ECU 800. The off-road switch 830 is switched on as a result of an operation by the driver when the driver desires the vehicle to travel off-road. When the off-road switch 830 is switched on, the driver can select the running capability of the vehicle through operation of the touch panel 832, as an operating device, as described below. An operating device different from the touch panel 832 may also be used. For instance, the operating device may be configured in the form of an input interface such as a display having a display function alone, a switch, a dial or the like. The operating device may be made up of a switch or dial alone.

A vehicle in which the transfer 500 has an auxiliary transmission and the driver can select between high gear and low gear through operation of a transfer position switch may be configured so as to select the running capability of the vehicle if low gear is selected.

The ECU 800 controls various equipment items to put the vehicle under a desired travel condition, on the basis of the signals sent by the position switch 806, the accelerator depression amount sensor 810, the depression force sensor 814, the engine revolutions sensor 820, the input shaft revolutions sensor 822, the output shaft revolutions sensor 824 and so forth, and on the basis of maps and programs stored in the ROM 802.

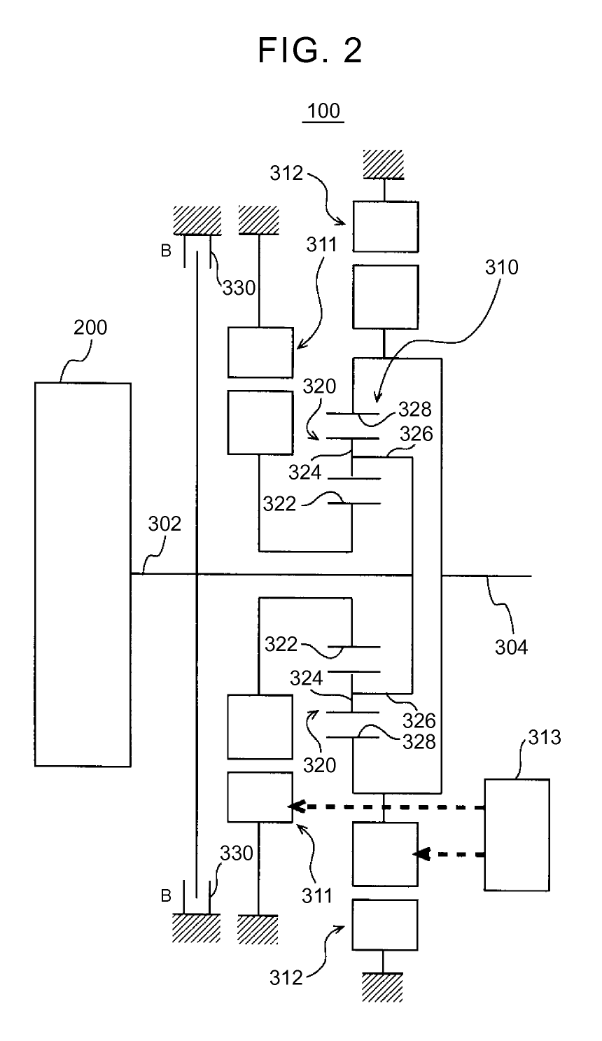

The hybrid system 100 will be explained next with reference to FIG. 2. The hybrid system 100 has the engine 200, a power split mechanism 310, a first motor generator 311 and a second motor generator 312. The power split mechanism 310 splits the output of the engine 200 that is inputted to the input shaft 302 between the first motor generator 311 and an output shaft 304. The power split mechanism 310 is made up of a planetary gear 320.

The planetary gear 320 has a sun gear 322, pinion gears 324, a carrier 326 and a ring gear 328. The carrier 326 supports the pinion gears 324 so that the pinion gears 324 can rotate and revolve. The ring gear 328 meshes with the sun gear 322 by way of the pinion gears 324.

In the power split mechanism 310, the carrier 326 is connected to the input shaft 302, i.e. to the engine 200. The rotation of the carrier 326 can be suppressed by the brake 330. That is, the revolutions of the carrier 326 and the revolutions of the output shaft of the engine 200 can be brought to zero through engagement of the brake 330. The sun gear 322 is connected to the first motor generator 311. The ring gear 328 is connected to the output shaft 304.

The power split mechanism 310 functions as a differential device through relative rotation of the sun gear 322, the carrier 326 and the ring gear 328 with respect to each other. By the differential function of the power split mechanism 310, the output of the engine 200 can be split between the first motor generator 311 and the output shaft 304.

The power split mechanism 310 functions as a continuously variable transmission through generation of power by the first motor generator 311, using part of the split output of the engine 200, and through rotational driving of the second motor generator 312 using the electric power generated by the first motor generator 311.

The first motor generator 311 and the second motor generator 312 are three-phase alternate current electric rotating machines. The first motor generator 311 is connected to the sun gear 322 of the power split mechanism 310. The second motor generator 312 is provided with a rotor configured so as to rotate integrally with the output shaft 304.

Electric power from a battery 313 is supplied to the first motor generator 311 and the second motor generator 312. The battery 313 can be charged with electric power by causing the first motor generator 311 to operate as a generator by being driven by the engine 200. The battery can also be charged with electric power generated by the second motor generator 312 during regenerative braking.

The engine 200, the first motor generator 311 and the second motor generator 312 are controlled in such a way so as to satisfy a target driving torque of the vehicle that is calculated on the basis of, for instance, the accelerator depression amount and the vehicle speed, and in such a way so as to achieve optimal fuel economy in the engine 200.

As an example, the vehicle travels using the second motor generator 312 alone, or both the first motor generator 311 and the second motor generator 312, as a drive source, when target driving torque is smaller than a predefined engine start threshold value. The travel mode in which motor generators alone are utilized will be referred to hereafter as EV travel mode.

When by contrast the target driving torque is equal to or higher than the engine start threshold value, the engine 200 is started, and the vehicle travels using the engine 200 alone or both the engine 200 and the second motor generator 312, as a drive source. The travel mode in which the engine 200 is used will be referred to hereafter as HV travel mode. The engine 200 is cranked by the first motor generator 311 upon start of the engine 200. Upon cranking of the engine 200, the second motor generator 312 is acted upon by torque in a direction such that the revolutions of the second motor generator 312 are lowered. Accordingly, the second motor generator 312 outputs a reaction torque. This torque is expended for cracking alone, and is not used for travel (this torque is cancelled by the reaction torque, and hence no torque is transmitted to the automatic transmission 400).

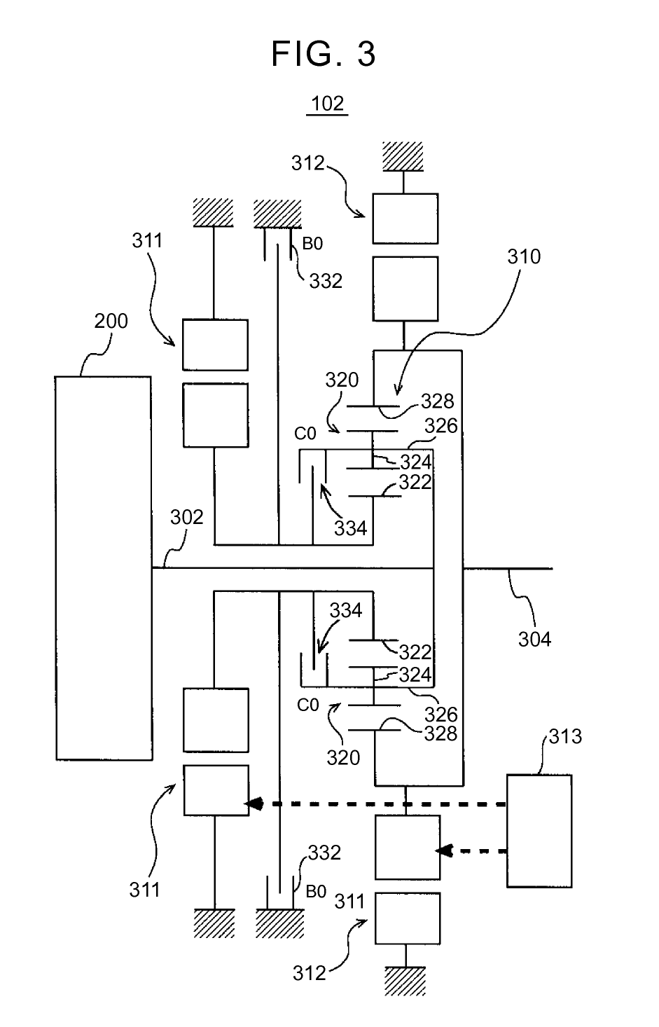

A hybrid system 102 illustrated in FIG. 3 may be used instead of the hybrid system 100 illustrated in FIG. 2. In the hybrid system 102, the rotation of the sun gear 322 may be suppressed by a brake 332. That is, the revolutions of the sun gear 322 and the revolutions of the rotor of the first motor generator 311 can be brought to zero through engagement of the brake 332.

In the hybrid system 102, the sun gear 322 and the carrier 326 may be connected by a clutch 334. That is, the differential function of the power split mechanism 310 can be locked through engagement of the clutch 334.

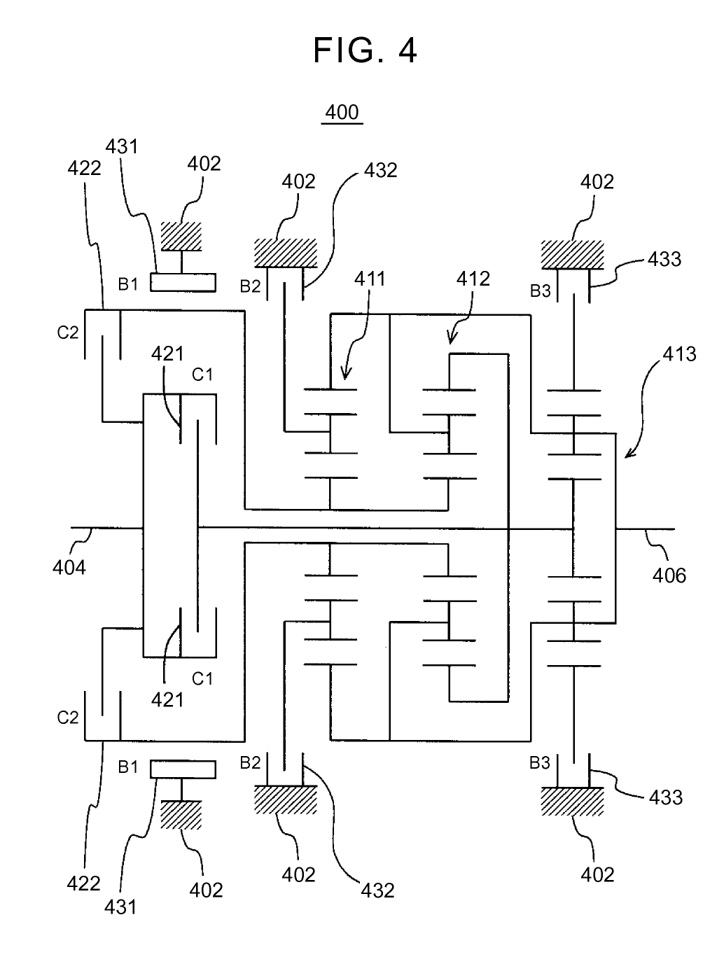

The automatic transmission 400 will be explained next with reference to FIG. 4. The automatic transmission 400 has an input shaft 404 as an input rotation member that is disposed on a common axis, inside a case 402 as a non-rotating member attached to the vehicle body, and has also an output shaft 406 as an output rotation member.

The input shaft 404 is connected to the output shaft 304 of the power split mechanism 310. Therefore, the input shaft revolutions NI of the automatic transmission 400 and the output shaft revolutions of the power split mechanism 310, i.e. the revolutions NR of the ring gear 328 (revolutions of the second motor generator 312) are identical.

The automatic transmission 400 has three planetary gears 411 to 413 of single pinion type, as well as five friction engagement elements, namely a C1 clutch 421, a C2 clutch 422, a B1 brake 431, a B2 brake 432 and a B3 brake 433.

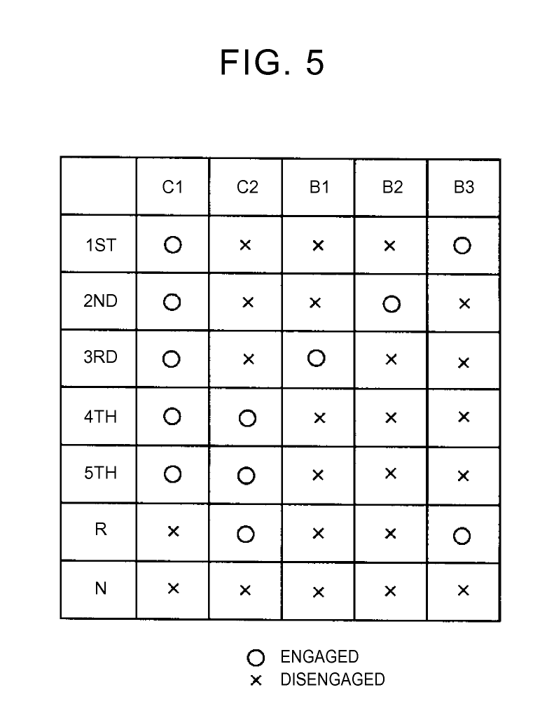

Five forward gears, namely a first through a fifth gear, are established in the power train through engagement of the friction engagement elements of the automatic transmission 400 in the combinations illustrated in operation chart of FIG. 5. Specifically, the speed ratios in the power train vary in accordance with the five forward gears.

In a state where a gear is established in the automatic transmission 400, the torque (output torque of the hybrid system 100) that is inputted from the ring gear 328 of the power split mechanism 310 to the automatic transmission 400 is transmitted to the front wheels 600 and the rear wheels 700, as drive wheels.

In the neutral state of the automatic transmission 400 all the friction engagement elements are brought to a disengaged state. Transmission of the torque from the ring gear 328 of the power split mechanism 310 to the front wheels 600 and the rear wheels 700 is cut off in the neutral state of the automatic transmission 400.

As illustrated in FIG. 5, the friction engagement elements that are engaged upon establishment of the fourth gear and the friction engagement elements that are engaged upon establishment of the fifth gear are identical. That is, the speed ratio in the automatic transmission 400 is identical for the fourth gear and the fifth gear. On the other hand, the speed ratios in the power split mechanism 310 upon the fourth gear is different from the speed ratios in the power split mechanism 310 upon the fifth gear.

Upon establishment of the fourth gear, rotation of the first motor generator 311 in the power split mechanism 310 is allowed, whereby the engine revolutions and the revolutions of the output shaft 304 are equalized, and,the speed ratio in the power split mechanism 310 becomes “1”. Upon establishment of the fifth gear, by contrast, the revolutions of the first motor generator 311 are set to “0”, and, as a result, the revolutions of the output shaft 304 become higher than the engine revolutions, and the speed ratio in the power split mechanism 310 is brought to a value smaller than “1”.

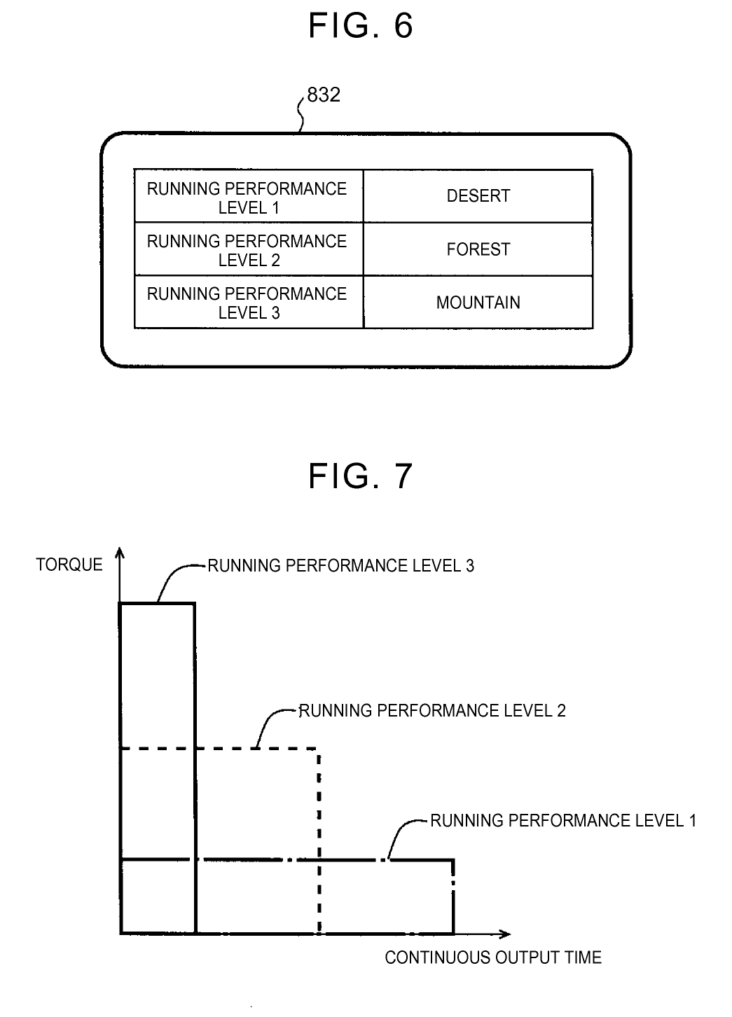

A method for designating the running capability of the vehicle using the touch panel 832 will be explained next with reference to FIG. 6. If the off-road switch 830 is switched on, the road surface environment and running performance levels corresponding to respective road surface conditions are displayed, as an example, on the touch panel 832. In the embodiment, a running performance level corresponding to “desert” is “1”, a running performance level corresponding to “forest” is “2”, and a running performance level corresponding to “mountain” is “3”. The higher the running performance level, the greater the torque that is required. The number of running performance levels is not limited to “3”, and may be any number so long as there is a plurality of levels. Further, a specific running performance level may be set to be selected as an initially set level without having been selected by the driver.

The driver selects a running performance level corresponding to the road surface environment. The running capability of the vehicle is selected through selection of the running performance level. The higher the running performance level, the higher is the running capability that is selected.

The running capability of the vehicle in the embodiment is defined by torque and by a continuous output time, as illustrated in FIG. 7. The running capability of the vehicle illustrated in FIG. 7 is an example, and the running capability of the vehicle may be defined by one alone from among the torque and continuous output time. Power (the product of torque and rotational speed) may be used herein instead of torque.

In FIG. 7 a solid line denotes the running capability of the vehicle corresponding to a running performance level 3. A dashed line denotes the running capability of the vehicle corresponding to a running performance level 2. A dot-dash-line denotes the running capability of the vehicle corresponding to a running performance level 1. As illustrated in FIG. 7, the higher the running performance level, the higher is the torque that is set. The higher the running performance level, the shorter is the continuous output time that is set. The respective running capability of the vehicle corresponding to each running performance level is established beforehand by a developer and is stored in, for instance, the ROM 802 of the ECU 800. In the embodiment, the term continuous output time denotes the longest time over which a desired torque can be outputted continuously.

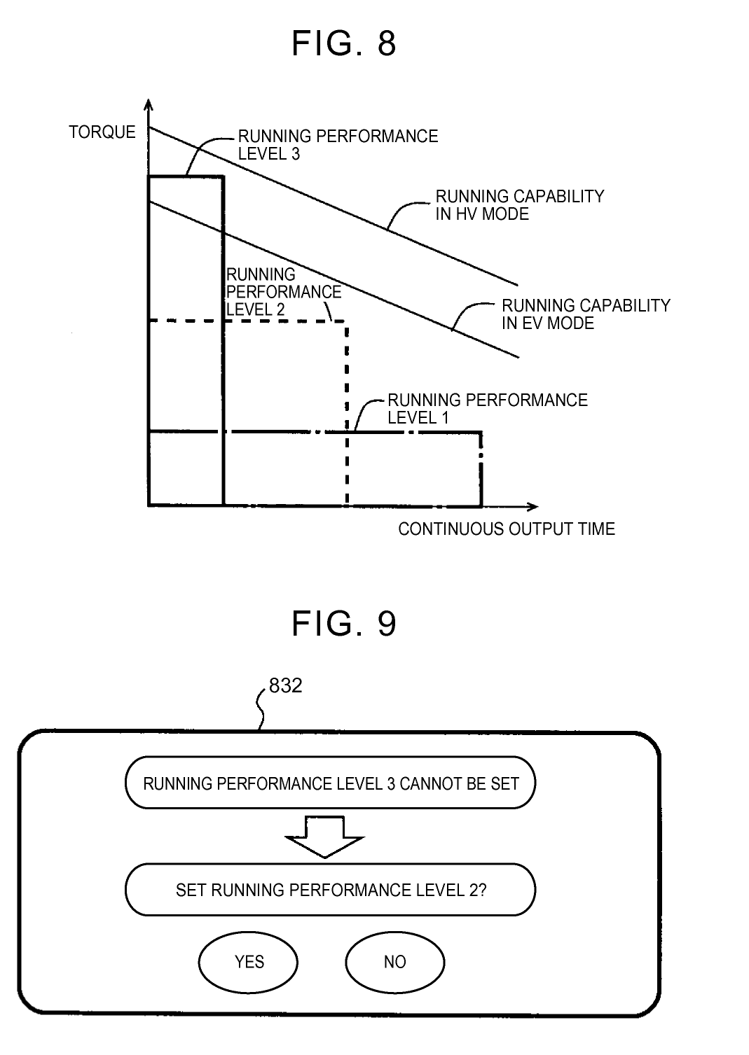

Upon designation of the running capability of the vehicle, the ECU 800 determines whether the selected running capability of the vehicle can be achieved or not. Specifically, the ECU 800 calculates the running capability to be achieved in the HV mode and the running capability to be achieved in the EV mode, as illustrated in FIG. 8.

When the selected running capability of the vehicle exceeds the running capability to be achieved in the HV mode, it is determined that the selected running capability of the vehicle is not realizable. If the selected running capability of the vehicle is not realizable, the touch panel 832 displays, as an example, a sign that the selected running capability cannot be achieved, as illustrated in FIG. 9. Accordingly, the driver is notified that the selected running capability of the vehicle cannot be achieved. A method that involves sound, light, vibration or the like may be resorted to notify the driver that the selected running capability of the vehicle cannot be achieved.

The example in FIG. 9 illustrates an instance where the running capability corresponding to the running performance level 3 cannot be achieved. In the embodiment, the touch panel 832 prompts changeover to a running performance level that is lower than the running performance level that is displayed as being not realizable.

When the selected running capability of the vehicle is below the running capability to be achieved in the HV mode, it is determined that the selected running capability of the vehicle can be achieved. In this case, the vehicle is run in the EV mode if the selected running capability of the vehicle is below the running capability to be achieved in the EV mode. Conversely, the vehicle is run in the HV mode if the selected running capability of the vehicle exceeds the running capability to be achieved in the EV mode. In the example illustrated in FIG. 8, all running capability levels can be achieved, although the vehicle is run in the HV mode if the running performance level 3 is selected, while the vehicle is run in the EV mode if the running performance level 2 or the running performance level 1 is selected.

The running capability to be achieved in the HV mode is calculated by the ECU 800 in consideration of a predefined maximum engine torque that is defined on the basis of the specifications of the engine 200 and the maximum torque and the continuous output time of the second motor generator 312 as determined by the basis of the state of the battery 313.

Similarly, the running capability to be achieved in the EV mode is calculated by the ECU 800 in consideration of the maximum torque and continuous output time by the second motor generator 312 and the first motor generator 311 as determined by the state of the battery 313. Specifically, the running capability to be achieved in the EV mode illustrated in FIG. 8 is the running capability of the vehicle at the time where both the second motor generator 312 and the first motor generator 311 are used as a drive source.

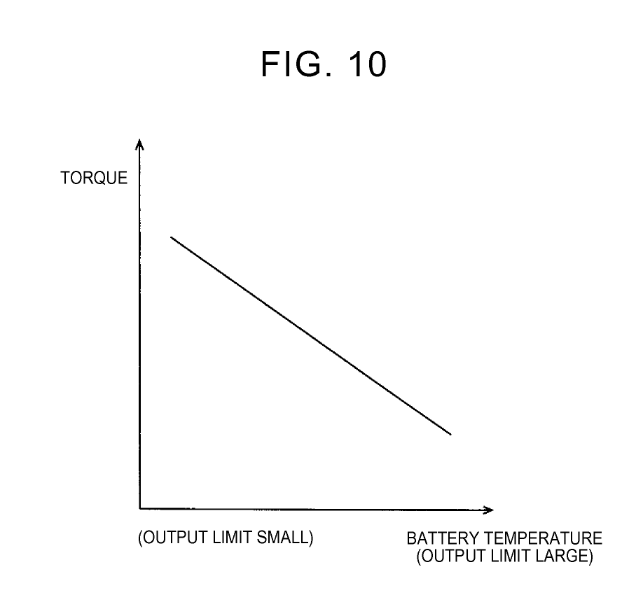

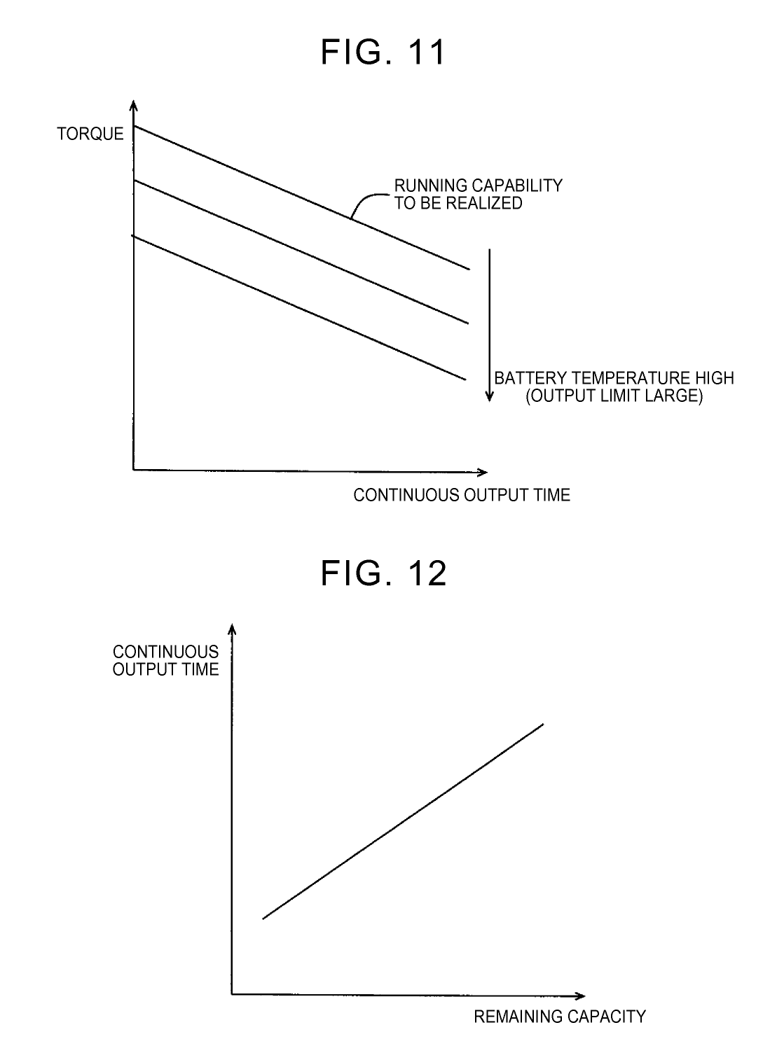

As an example, the higher the temperature of the battery 313, the more the discharge power from the battery 313 is limited so as to prevent further rises in temperature. Accordingly, the higher the temperature of the battery 313, the greater is the drop in maximum torque of the second motor generator 312 and in maximum torque of the first motor generator 311, as illustrated in FIG. 10. Therefore, the higher the temperature of the battery 313, the greater the shift, to a lower torque, of the curves that denote the running capability to be achieved in the HV mode and the running capability to be achieved in the EV mode, as illustrated in FIG. 11.

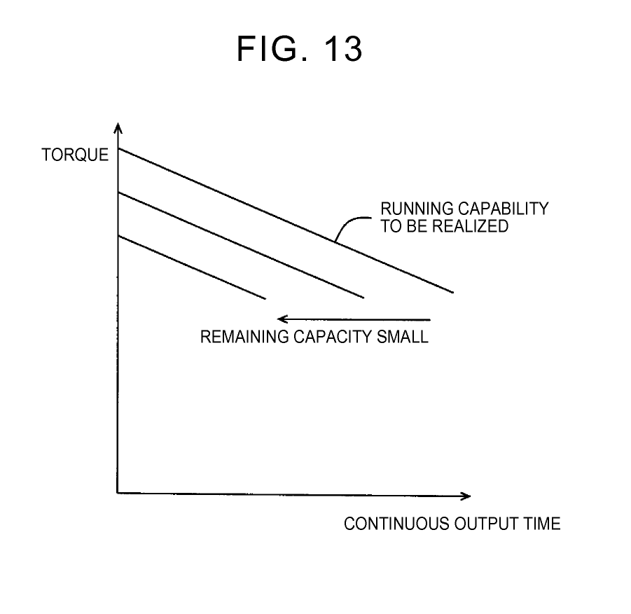

The smaller the remaining capacity of the battery 313, the shorter becomes the time over which the torque from the second motor generator 312 and the first motor generator 311 can be outputted. Accordingly, the smaller the remaining capacity of the battery 313, the shorter the continuous output time becomes, as illustrated in FIG. 12. As the remaining capacity of the battery 313 decreases, therefore, the lines that denote the running capability to be achieved in the EV mode and the running capability to be achieved in the HV mode shift in a direction of decreasing continuous output time, as illustrated in FIG. 13.

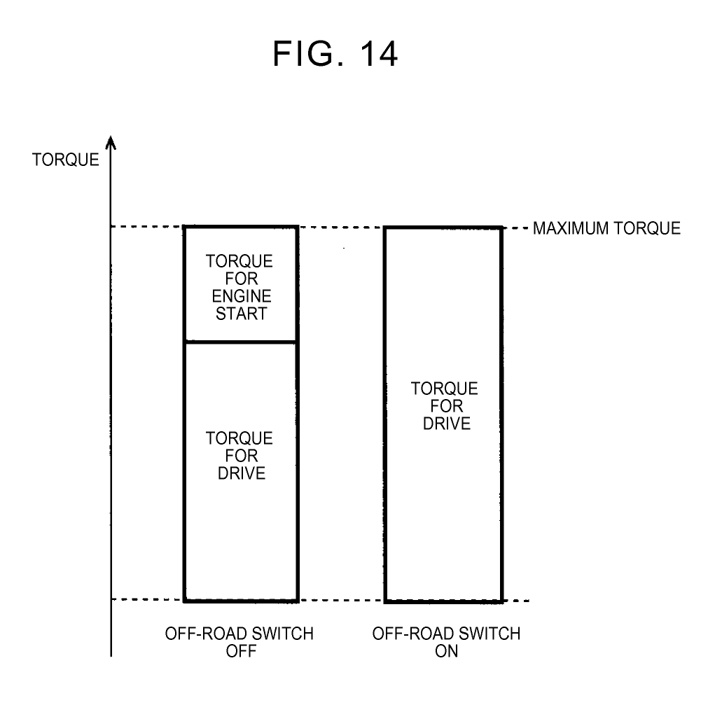

As illustrated in FIG. 14, the maximum torque of the second motor generator 312 that is used in the calculation of the running capability to be achieved in the HV mode and the running capability to be achieved in the EV mode is larger than the torque for driving of the second motor generator 312 that is used for travel of the vehicle when the off-road switch 830 is off.

As explained above, the first motor generator 311 and the second motor generator 312 must secure enough torque as required for cranking of the engine 200. The torque for driving that is used for travel is thus limited by the torque that is required for cranking. In a case where the off-road switch 830 is switched on and the running capability of the vehicle is selected, the travel mode is fixed and does not change over to the HV mode in which the engine 200 is started while in the EV mode. Accordingly, there is no need to secure torque required for cranking. It becomes possible therefore to use the entirety of the maximum torque of the first motor generator 311 and the second motor generator 312 as torque for driving. In the embodiment, as a result, the running capability to be achieved using the motor generators alone when the running capability of the vehicle is selected is calculated to be larger than the running capability to be achieved using only the motor generators when the running capability of the vehicle is not selected. In a case where the off-road switch 830 is switched on and the vehicle travels using the motor generators alone at the selected running capability, i.e. if the selected running capability of the vehicle is smaller than the running capability to be achieved in the EV mode, there is increased the torque for driving from the first motor generator 311 and the second motor generator 312, as described above. Therefore, the running capability to be achieved using the motor generators alone is increased as compared with a case where the running capability is not selected (when the off-road switch 830 is off).

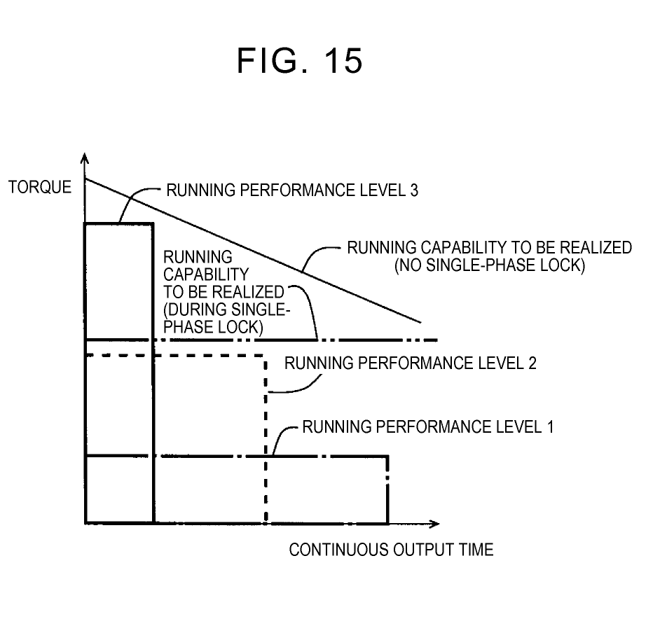

In the embodiment, the running capability to be achieved in the EV mode is calculated on the basis of the torque at a time of no occurrence of single-phase lock. As used herein, the term single-phase lock denotes a phenomenon whereby current concentrates in one phase owing to failed phase change in a case where the revolutions of a motor generator, which is a three-phase alternate current electric rotating machine, drop to “0”. The torque of the motor generator drops sharply when single-phase lock occurs. In FIG. 15, the running capability to be achieved in the HV mode or EV mode upon occurrence of single-phase lock is denoted by a two-dot chain line. Single-phase lock can be avoided, for instance, by causing the motor generators to rotate through sliding of the C1 clutch 421, which is the input clutch of the automatic transmission 400.

In the embodiment, accordingly, there is selected a running capability (running performance level 3 in the example illustrated in FIG. 15) that exceeds the running capability to be achieved in the HV mode or the EV mode when single-phase lock occurs, and slip control of the C1 clutch 421 is executed if single-phase lock occurs (if the revolutions of the motor generator drop to “0”).

On the other hand, slip control of the C1 clutch 421 is not necessary, and is not executed, if the selected running capability (running performance level 1 or 2 in the example illustrated in FIG. 15) is below the running capability to be achieved in the HV mode or EV mode when single-phase lock occurs.

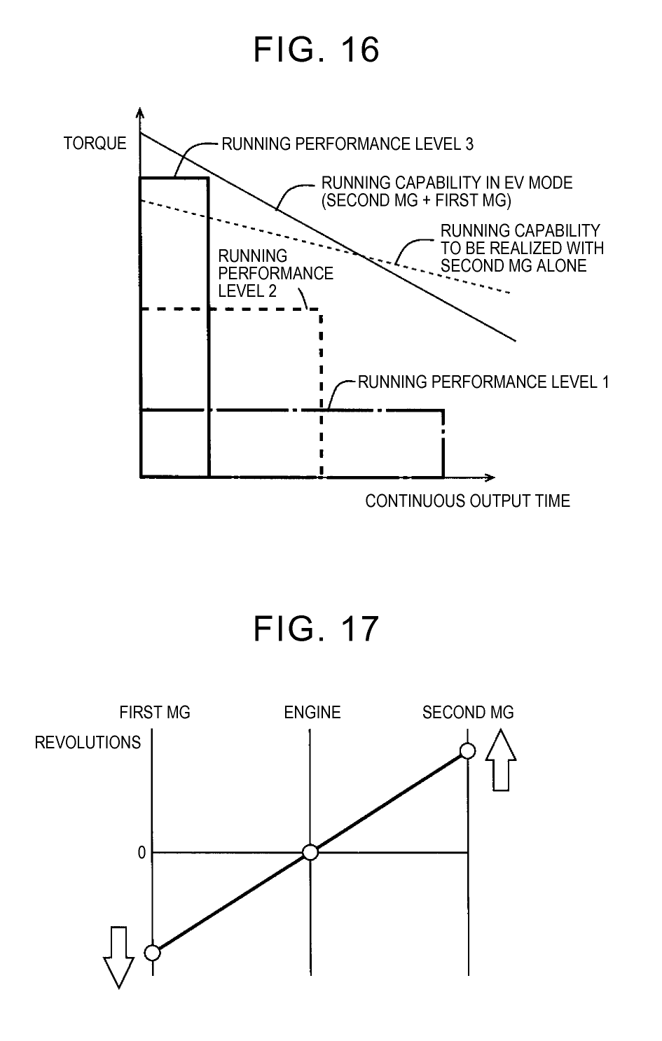

In the embodiment, as illustrated in FIG. 16, the vehicle is run using the second motor generator 312 alone if the selected running capability (running performance level 1 or 2 in the example illustrated in FIG. 16) is below the running capability to be achieved using the second motor generator 312 alone.

On the other hand, the vehicle is run using the second motor generator 312 and the first motor generator 311 if the selected running capability (running performance level 3 in the example illustrated in FIG. 16) exceeds the running capability to be achieved using the second motor generator 312 alone.

FIG. 17 illustrates a colinear chart of a case where the rotation of the carrier 326 is suppressed by the brake 330, as in the hybrid system 100 illustrated in FIG. 2. In this case, torque is outputted, in the direction denoted by the arrows in FIG. 17, to the second motor generator 312 and the first motor generator 311, in a state where the revolutions of the engine 200 have been brought to “0” through engagement of the brake 330, as illustrated in FIG. 17.

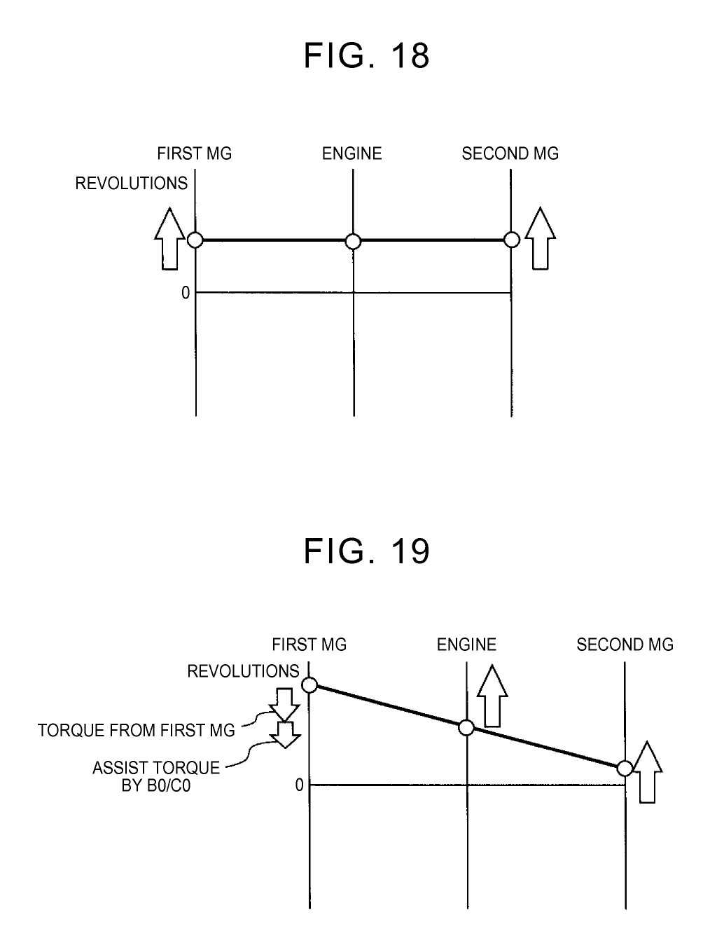

FIG. 18 illustrates a colinear chart of an instance where the differential function of the power split mechanism 310 can be locked through engagement of the clutch 334, as in the hybrid system 102 illustrated in FIG. 3. In this case, torque is outputted, in the direction denoted by the arrow of the FIG. 18, to the second motor generator 312 and first motor generator 311, with the clutch 334 in an engaged state, as illustrated in FIG. 18.

Torque assist through slip control, such as the one illustrated in FIG. 19, can thus be executed in the hybrid system 102 illustrated in FIG. 3. For instance, the torque of the first motor generator 311 is limited and the reaction force by the first motor generator 311 decreases during travel in the HV mode. As a result, slip control of the brake 332 or the clutch 334 is executed in a situation where the torque from the engine 200 that is transmitted to the ring gear 328 can decrease. Torque can be assisted as a result by the brake 332 or the clutch 334.

For instance, the revolutions of the first motor generator 311 increase when the engine 200 is operated at high torque at times of low vehicle speed; as a result, the electric power generated by the first motor generator 311 may exceed the charging power of the battery 313. The torque of the first motor generator 311 may be limited (may be lowered) in such a case. The decrement in torque from the first motor generator 311 is compensated through slip control of the brake 332 or the clutch 334. Slip control of the brake 332 or clutch 334 may be set to be executed when the torque of the first motor generator 311 is limited on account of factors other than discharged power.

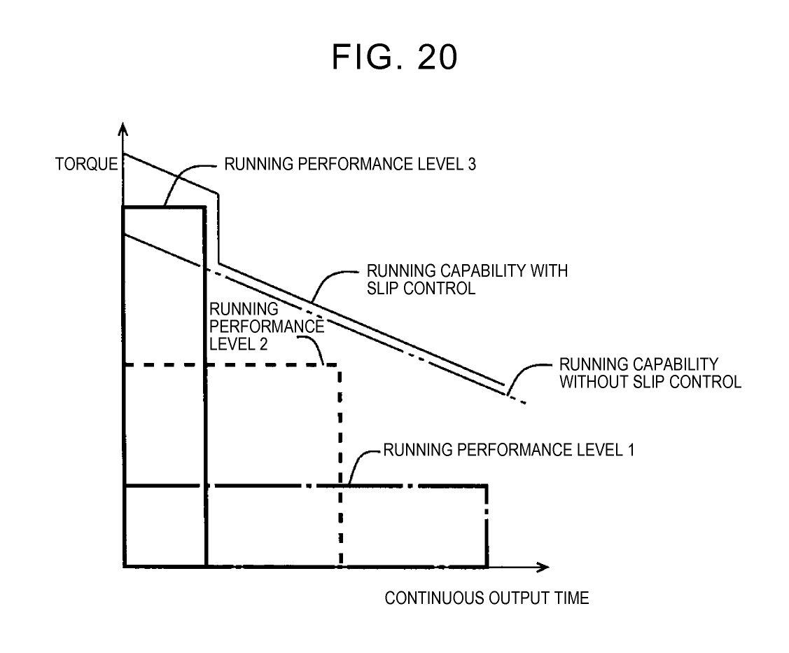

Whether or not to execute slip control of the brake 332 or the clutch 334 is determined, as illustrated in FIG. 20 as an example, by comparing the running capabilities from each other, such as; (1) the selected running capability of the vehicle, (2) the running capability to be achieved through slip control of the brake 332 or the clutch 334 in a state where the torque of the first motor generator 311 is limited, and (3) the running capability to be achieved without slip control in a state where the torque of the first motor generator 311 is limited. As an example, a restricted amount of torque established beforehand is used to calculate the running capability of the vehicle that is to be achieved.

In the example illustrated in FIG. 20, slip control of the brake 332 or the clutch 334 is executed when the torque of the first motor generator 311 is limited during travel in the HV mode, in a case where the running performance level 3 is selected. By contrast, slip control of the brake 332 or the clutch 334 is not executed in a case where the running performance level 1 or 2 is selected.

The brake 332 or the clutch 334 may generate heat in a case where slip control of the brake 332 or the clutch 334 is executed, and hence slip control is executed within a limited length of time, in order to protect the brake 332 or the clutch 334.

Accordingly, the time over which the torque is increased is limited for the running capability to be achieved through slip control, illustrated in FIG. 20.

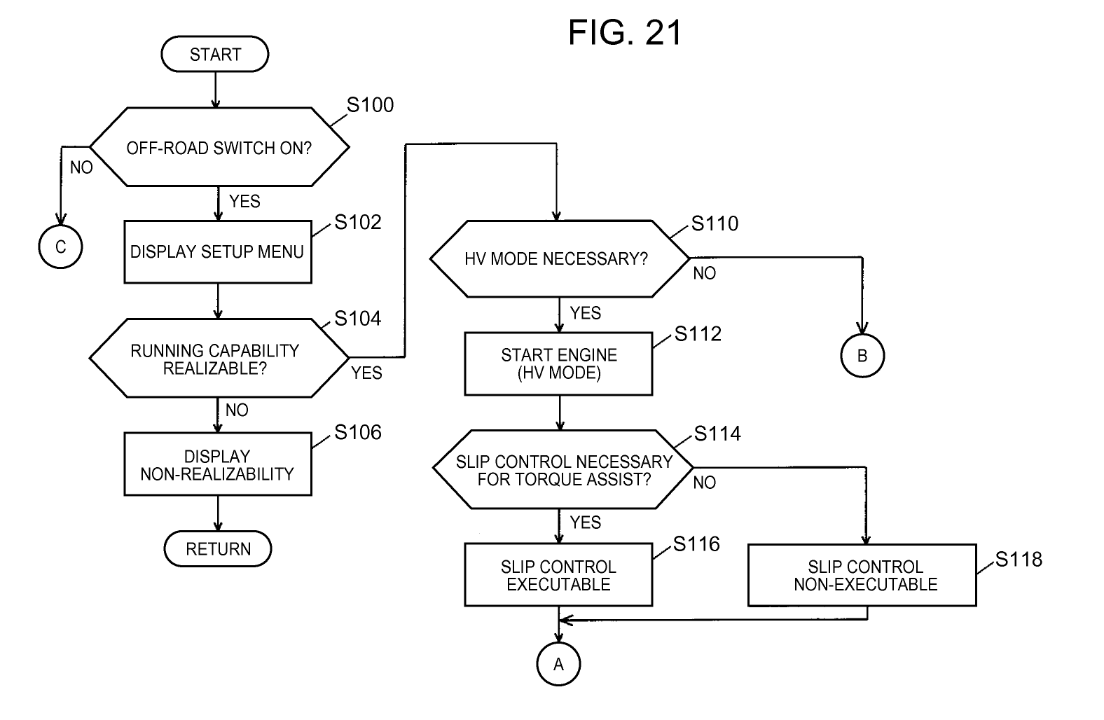

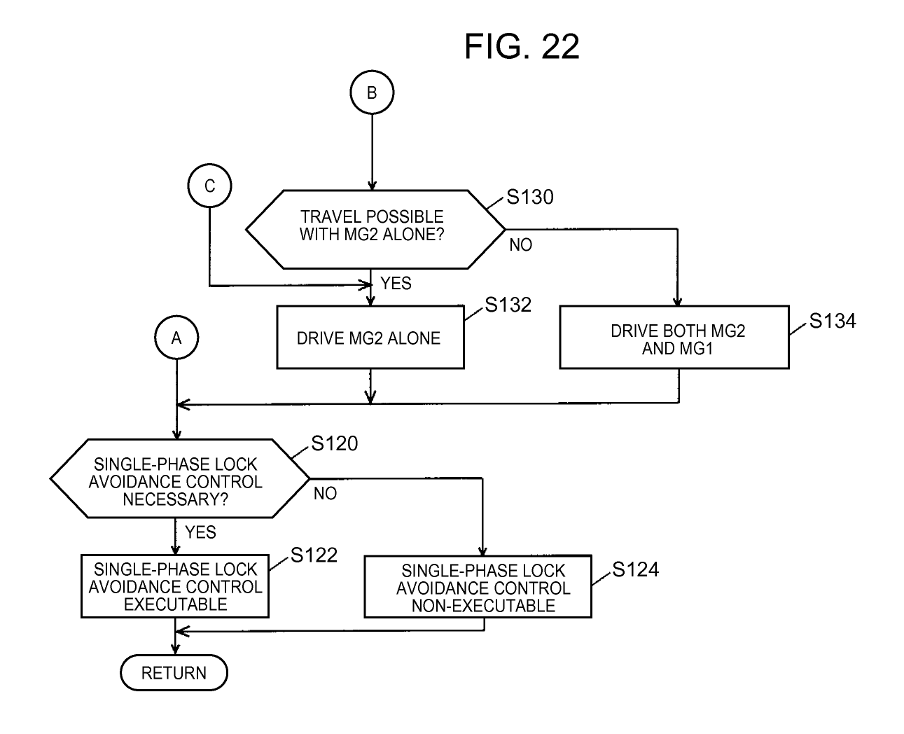

The process executed by the ECU 800 will be explained next with reference to FIG. 21 and FIG. 22. In step (hereafter, S for short) 100, it is determined whether the off-road switch 830 is on or not. If the off-road switch 830 is not on (NO in S100), the control proceeds to S132 described below. When the off-road switch 830 is switched on (YES in S100), a setup menu of running performance level is displayed, in S102, on the touch panel 832. In S104 it is determined whether the running capability corresponding to the running performance level selected by the driver can be achieved or not.

If not (NO in S104), the touch panel 832 displays, in S106, that the running capability corresponding to the running performance level selected by the driver cannot be achieved.

If the running capability can be achieved (YES in S104), it is determined in S110 whether travel in the HV mode is necessary or not. If travel in the HV mode is necessary (YES in S110), the engine 200 is started in S112, and travel in the HV mode is initiated.

For instance, if the vehicle is a vehicle with enabled torque assist through slip control of the brake 332 or the clutch 334, as in the hybrid system 102 illustrated in FIG. 3, it is determined, in S114, whether slip control of the brake 332 or the clutch 334 is necessary or not. If slip control of the brake 332 or the clutch 334 is necessary (YES in S114), slip control of the brake 332 or the clutch 334 is set in S116 as executable. If slip control is unnecessary (NO in S114), slip control is set in S118 as non-executable.

In S120 it is determined whether slip control of the C1 clutch 421 for avoidance of single-phase lock (hereafter also referred to as single-phase lock avoidance control) is necessary or not. If single-phase lock avoidance control is necessary (YES in S120), single-phase lock avoidance control is set in S122 as executable. If single-phase lock avoidance control is not necessary (NO in S120), single-phase lock avoidance control is set in S124 as non-executable.

If travel in the HV mode is not necessary (NO in S110), it is determined, in S130, whether or not travel is possible using the second motor generator 312 alone. If travel using the second motor generator 312 alone is not possible (NO in S130), travel in the EV mode, in which both the second motor generator 312 and the first motor generator 311 are used, is initiated in 5134.

If travel using the second motor generator 312 alone is possible (YES in S130), the vehicle travels, in S132, in the EV mode in which the second motor generator 312 alone is used.

In the configuration of the embodiment, specifically, the ECU 800 calculates the running capability to be achieved using an electric motor alone, in a case where the running capability of the vehicle is selected, to a larger value than that of the running capability of the running capability to be achieved using an electric motor alone in a case where the running capability of the vehicle is not selected.

The embodiments disclosed herein are, in all features thereof, exemplary in nature, and are not meant to be limiting in any way. The scope of the invention, which is defined by the appended claims and not by the explanation above, is meant to encompass equivalents as well as all modifications of the claims.

What is claimed is:

1. A control device of a vehicle, the vehicle including an electric motor and an engine, the control device comprising:
an operating device configured to select a running capability of the vehicle; and
a controller configured to increase a running capability to be achieved using the electric motor alone, in a case where the vehicle travels using the electric motor alone according to the selected running capability, as compared with a case where the vehicle travels using the electric motor alone and the running capability is not selected.

2. The control device of a vehicle according to claim 1, wherein
the controller is configured to calculate a first running capability to be achieved using the electric motor alone when the running capability is selected, to be larger than a second running capability to be achieved using the electric motor alone when the running capability is not selected, and
the controller is configured to cause the vehicle to travel using the electric motor alone, when the selected running capability is equal to or smaller than the first running capability.

3. The control device of a vehicle according to claim 2, wherein
the controller is configured to cause the vehicle to travel using the engine when the selected running capability exceeds the first running capability.

4. The control device of a vehicle according to claim 3, further comprising:
a notifying device configured to notify the driver that the selected running capability cannot be achieved when the selected running capability exceeds the running capability to be achieved using the engine.

5. The control device of a vehicle according to claim 1, wherein
the electric motor is installed in plurality, and
the controller is configured to cause the vehicle to travel using the plurality of electric motors when the selected running capability exceeds the running capability to be achieved using one of the electric motors alone.

6. The control device of a vehicle according to claim 1, wherein the running capability to be achieved is established on the basis of torque that is outputted from the vehicle and on the basis of a continuous output time of the vehicle.

7. The control device of a vehicle according to claim 6, wherein
the continuous output time of the vehicle is a longest time over which a predefined torque can be continuously outputted.

8. The control device of a vehicle according to claim 6, wherein the torque at the time of achieving the selected running capability using the engine is a maximum torque of the engine and a maximum torque of the electric motor.

9. The control device of a vehicle according to claim 6, wherein the torque at the time of achieving the selected running capability using the electric motor is a maximum torque of the electric motor.

10. The control device of a vehicle according to claim 4, wherein
the operating device includes a display device and the notifying device.

11. A control method for a vehicle, the vehicle including an electric motor and an engine, the control method comprising:
increasing a running capability to be achieved using the electric motor alone, in a case where the vehicle travels using the electric motor alone according to the running capability that is selected, as compared with a case where the vehicle travels using the electric motor alone and the running capability is not selected.

12. The control method for a vehicle according to claim 11, wherein
a first running capability to be achieved using the electric motor alone when the running capability is selected is made larger than a second running capability to be achieved using the electric motor alone when the running capability is not selected, and
the vehicle is caused to travel using the electric motor alone when the selected running capability is equal to or smaller than the first running capability.

13. The control method for a vehicle according to claim 12, wherein
the vehicle is caused to travel using the engine when the running capability selected exceeds the first running capability.

14. The control method for a vehicle according to claim 13, wherein
the driver is notified that the selected running capability cannot be achieved when the running capability selected exceeds the running capability to be achieved using the engine.

15. The control method for a vehicle according to claim 11, wherein
the vehicle is caused to travel using a plurality of electric motors when the running capability selected exceeds the running capability to be achieved using one of the electric motors alone.

16. The control method for a vehicle according to claim 11, wherein the running capability to be achieved is established on the basis of torque that is outputted from the vehicle and on the basis of a continuous output time of the vehicle.
